(19) United States
(12) Patent Application Publication
(10) Pub. No.: US 2023/0252353 A1
(43) Pub. Date: Aug. 10, 2023

(54) ON-DEVICE TRAINING METHOD TO TRAIN AN ARTIFICIAL INTELLIGENT MODEL AND A SYSTEM THEREFOR

(71) Applicant: Samsung Electronics Co., Ltd., Suwon-si (KR)

(72) Inventors: Prasanna R, Bengaluru (IN); Praveen Doreswamy NAIDU, Bengaluru (IN); Raman Pratap SINGH, Bengaluru (IN)

(21) Appl. No.: 18/175,830

(22) Filed: Feb. 28, 2023

Related U.S. Application Data
(63) Continuation of application No. PCT/KR2023/001782, filed on Feb. 8, 2023.

(30) Foreign Application Priority Data
Feb. 8, 2022 (IN) 202241006707
Jul. 15, 2022 (IN) 202241006707

(51) Int. Cl. G06N 20/00

(52) U.S. Cl. CPC G06N 20/00

(57) ABSTRACT

An on-device training method to train an artificial intelligence (AI) model on a device and a system are provided. The method includes receiving a training request for initiating on-device training from one or more applications based on dataset for the on-device training of the AI model being obtained through the one or more applications. The method further comprises determining whether at least one policy of a plurality of predefined policies regarding state of at least one component included in the device is satisfied, based on the training request. The method also comprises training, based on the at least one policy being satisfied, the AI model using data associated with the one or more applications.

### CROSS-REFERENCE TO RELATED APPLICATION(S)

This application is a continuation application, claiming priority under §365(c), of an International Application No. PCT/KR2023/001782, filed on Feb. 8, 2023, which is based on and claims the benefit of an Indian Provisional Patent Application Number 202241006707, filed on Feb. 8, 2022, in the Indian Patent Office, and of an Indian Complete Patent Application Number 202241006707, filed on Jul. 15, 2022, in the Indian Patent Office, the disclosure of each of which is incorporated by reference herein in its entirety.

### TECHNICAL FIELD

The disclosure relates to an on-device training method to train an artificial intelligent model and a system therefor.

### BACKGROUND ART

Mobile/embedded devices have multiple sensors that collect enormous amount of user-generated data which possess the potential to provide a good insight on user profiles. Fine-tuning machine learning (ML) model behavior by training over that data to provide ‘one-to-one experience’ to an end user is called model personalization. Model personalization helps in anticipating what the end users need and provides some useful suggestions based on their want, without having the users to ask for it. It becomes possible to anticipate individual user needs and tailor recommendations (e.g., Keyboard) and app content (e.g., Smart widget) accordingly. Model personalization through on-device training takes usability of intelligent applications to a new level of user experience altogether. However, model personalization through on-device has following drawbacks:

Privacy Concerns- The user data is very susceptible to privacy concerns. Therefore, it is generally not a good practice to send them over a centralized server for training to fine tune the ML model behavior.

Resource Constraints- The main constraints are due to form-factor considerations. The device capabilities cannot be increased like adding storage, compute modules, battery without increasing the size of the device - forcing the on-device training framework to be lightweight.

Impact on user experience (UX)- The ML model has to be smaller, or training procedure has to be fast & lightweight, so that user experience is not hampered.

Effect on Device Stability- On-device training is a very challenging, iterative (long time), and computationally intensive process. The on-device training affects the power, performance and thermal stability and may cause undesirable effects to the device like sluggishness, device heating up and overload making it a frail solution.

Hence, there is a need for techniques for on-device training without any issues like privacy loss, divergence, and network latency upon sending sensitive data generated over the server for training/aggregation. Also, there is a need for such techniques that perform training on-device which is lightweight, faster, and suitable for embedded devices. Further, there is a need for a training system that strategizes training based on device state using the best compute modules available for offloading the training procedure.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to introduce a selection of concepts in a simplified format that are further described in the detailed description of the disclosure. This summary is not intended to identify key or essential inventive concepts of the disclosure, nor is it intended for determining the scope of the disclosure.

Additional aspects will be set forth in part in the description which follows and, in part, will be apparent from the description, or may be learned by practice of the presented embodiments.

In accordance with an aspect of the disclosure, an on-device training method to train an artificial intelligence (AI) model on a device is provided. The on-device training method includes receiving a training request for initiating on-device training from one or more applications based on dataset for the on-device training of the AI model being obtained through the one or more applications. The method further comprises determining whether at least one policy of a plurality of predefined policies regarding state of at least one component included in the device is satisfied, based on the training request. The method also comprises training, based on the at least one policy being satisfied, the AI model using data associated with the one or more applications.

In accordance with another aspect of the disclosure, an on-device training system to train an artificial intelligence (AI) model is provided. The on-device training system includes a receiving module configured to receive a training request for initiating the on-device training system from one or more applications based on dataset for the on-device training of the AI model being obtained through the one or more applications. The system also includes a determination module configured to determine whether at least one policy of a plurality of predefined policies regarding state of at least one component included in the device is satisfied, based on the training request. The system further includes a training module configured to train, based on the at least one policy being satisfied, the AI model using data associated with the one or more applications.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 illustrates a flow diagram depicting an on-device training method to train an artificial intelligence (AI) model, according to an embodiment of the disclosure;

FIG. 2 illustrates a block diagram of an on-device training system to train an AI model, according to an embodiment of the disclosure;

FIG. 3 illustrates a block diagram for determining if the policies are satisfied, according to an embodiment of the disclosure; and

FIGS. 4, 5, and 6 illustrate comparison between an AI keyboard using existing technique and method according to various embodiments of the disclosure.

Throughout the drawings, it should be noted that like reference numbers are used to depict the same or similar elements, features, and structures.

### BEST MODE

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It will be understood by those skilled in the art that the foregoing general description and the following detailed description are explanatory of the disclosure and are not intended to be restrictive thereof.

Reference throughout this specification to “an aspect,” “another aspect,” or similar language means that a particular feature, structure, or characteristic described in connection with the embodiment is included in at least one embodiment of the disclosure. Thus, appearances of the phrase “in an embodiment,” “in another embodiment,” and similar language throughout this specification may, but do not necessarily, all refer to the same embodiment.

The terms “comprises,” “comprising,” or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises... a” does not, without more constraints, preclude the existence of other devices or other sub-systems or other elements or other structures or other components or additional devices or additional sub-systems or additional elements or additional structures or additional components.

It should be noted that the terms “fused model,” “fused NN model,” and “connected model” may be used interchangeably throughout the specification and drawings.

The disclosure discloses lightweight on-device training techniques suitable for smart embedded devices with a new artificial intelligence (AI) module such as a backpropagation module that extends an on-device inference engine by efficiently reusing its optimized computation kernels. An on-device inference engine is already present in almost all embedded devices (such as Samsung Neural SDKP®, Tflite®, XNNpack®, QNNPack®, PytorchLite®, etc.) Hence, it is easier to represent the operations involved in backpropagation (such as loss functions, optimizers, and gradient calculations) as a series of operations that are already available in the inference engine, thereby reusing the inference engine. Further, computation kernels in on-device inference engines are mature, optimized and more suited for executing in embedded devices, hence, resulting in accelerated training of the model. This reutilization makes the technique very light-weight.

Further, the disclosed training technique intelligently strategizes training request scheduling, runtime optimizations and acceleration parameters considering the device state, thereby complementing on-device training engine to tackle the challenges in on-device training.

Embodiments of the disclosure will be described below in detail with reference to the accompanying drawings.

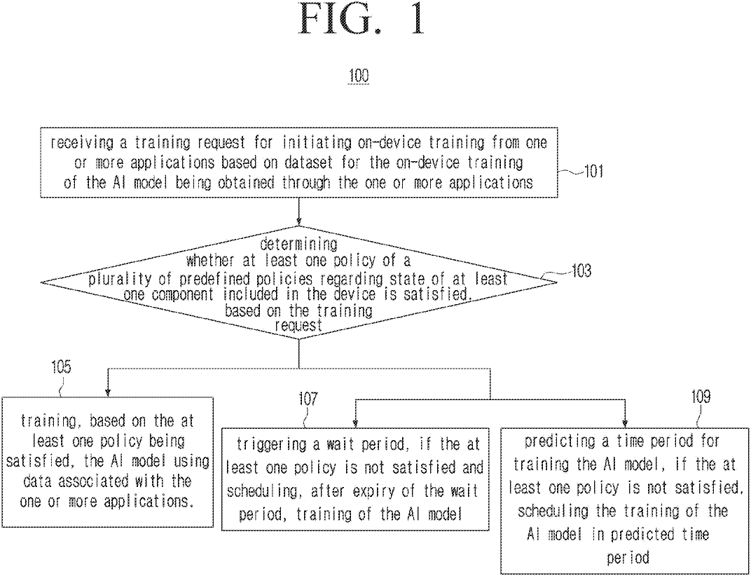

FIG. 1 illustrates a flow diagram depicting an on-device training method 100 to train an artificial intelligence (AI) model, according to an embodiment of the disclosure.

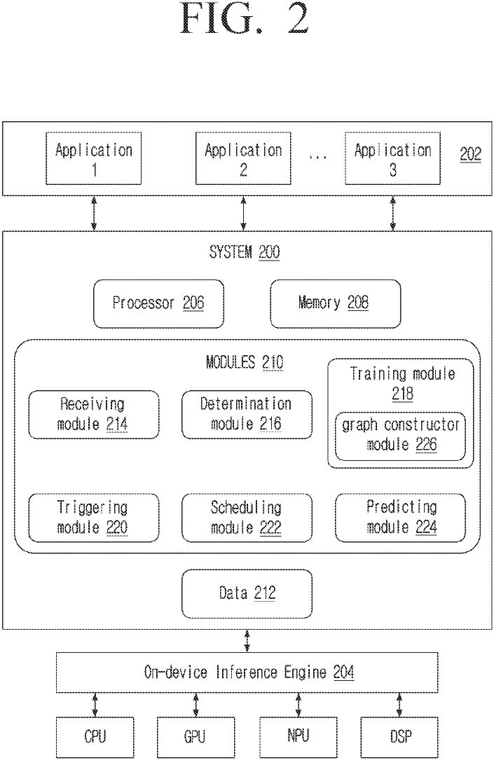

FIG. 2 illustrates a block diagram of an on-device training system 200 to train an artificial intelligence (AI) model, according to an embodiment of the disclosure. For the sake of brevity, the description of the FIGS. 1 and 2 are explained in conjunction with each other.

The system 200 may include, but is not limited to, a processor 206, memory 208, modules 210, and data unit 212. The modules 210 and the memory 208 may be coupled to the processor 206. The system 200 may be connected to one or more applications 202, such as application 1, application 2... application 3. The system 200 may also be connected to an on-device inference engine 204. The on-device inference engine 204 may be connected to various processing units of the device, such as a central processing unit (CPU), a graphics processing unit (GPU), a neural processing unit (NPU), a digital signal processor (DSP), etc.

The processor 206 can be a single processing unit or several modules, all of which could include multiple computing modules. The processor 206 may be implemented as one or more microprocessors, microcomputers, microcontrollers, digital signal processors, central processing modules, state machines, logic circuitries, and/or any devices that manipulate signals based on operational instructions. Among other capabilities, the processor 206 is configured to fetch and execute computer-readable instructions and data stored in the memory 208.

The memory 208 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM (EPROM), flash memories, hard disks, optical disks, and magnetic tapes.

The modules 210 amongst other things, include routines, programs, objects, components, data structures, etc., which perform particular tasks or implement data types. The modules 210 may also be implemented as, signal processor(s), state machine(s), logic circuitries, and/or any other device or component that manipulate signals based on operational instructions.

Further, the modules 210 can be implemented in hardware, instructions executed by a processing unit, or by a combination thereof. The processing unit can comprise a computer, a processor, such as the processor 206, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the disclosure, the modules 210 may be machine-readable instructions (software) which, when executed by a processor/processing unit, perform any of the described functionalities.

In an embodiment, the modules 210 may include a receiving module 214, a determination module 216, a training module 218, a triggering module 220, a scheduling module 222, and a predicting (or prediction) module 224. The training module 218 may also comprise a graph constructor module 226.

The various modules 214-226 may be in communication with each other. In an embodiment, the various modules 214-226 may be a part of the processor 206. In another embodiment, the processor 206 may be configured to perform the functions of modules 214-226. The data unit 212 serves, amongst other things, as a repository for storing data processed, received, and generated by one or more of the modules 210.

It should be noted that the system 200 may be a part of a device. In another embodiment, the system 200 may be connected to the device. It should be noted that the term “device” refers to any electronic devices used by a user such as a mobile device, a desktop, a laptop, personal digital assistant (PDA), or similar devices.

Referring to FIG. 1, at operation 101, the method 100 may comprise receiving a training request for initiating the on-device training from one or more applications based on dataset for the on-device training of the AI model being obtained through the one or more applications. In an embodiment, when the one or more applications have sufficient dataset for the on-device training, the one or more applications may transmit the training request to the system 200 to initiate the on-device training. Accordingly, the receiving module 214 may receive the training request from the one or more applications, such as applications 1, 2 and 3, as shown in FIG. 2. In an embodiment, the one or more applications may be artificial intelligence (AI) based applications. In an embodiment, the sufficient dataset may indicate that if the dataset is enough to train the AI model associated with the application. The determination of sufficient dataset may be configurable by the one or more applications and the meaning of sufficient dataset may be different for different applications. For example, a number of data in the dataset may be different for different applications. Further, the training request may include heuristic data. The heuristic data includes a number of operations in each layer of the AI model and time taken to execute the number of operations in each layer of the AI model. For example, the heuristic data may include number of floating operations (FLOPS), or Integer operations (OPS) required to execute each layer of the AI model.

Thereafter, at operation 103, the method 100 may comprise determining whether at least one policy of a plurality of predefined policies regarding state of at least one component included in the device is satisfied, based on the training request. In an embodiment, the plurality of predefined policies includes temperature of the device, state of battery recharge of the device, doze mode status of the device, priority of current tasks running on the device, availability of device resources. In particular, the determination module 216 determines if the on-device training is possible at a particular time or not, based on plurality of predefined policies such as the device state and availability of resources. The determination module 216 takes the device statistics such as load, temperature, availability of resources, power parameters etc., as inputs and determines if the policies are satisfied.

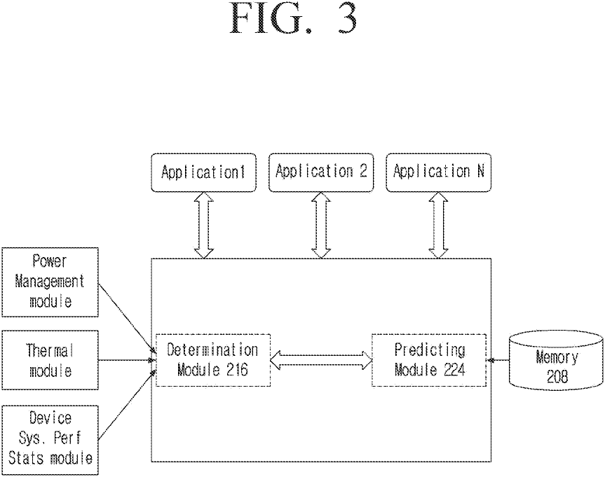

FIG. 3 illustrates a block diagram for determining if the policies are satisfied, according to an embodiment of the disclosure.

Referring to FIG. 3, the determination module 216 is connected to various modules of the device to receive device statistics such as a power management module 301 to receive power parameters of the device, a thermal module 303 to receive temperature of the device, a device system performance statistics module (DSPS) 305 to receive performance statistics of the device like availability of resources on the device etc. It should be noted that FIG. 3 illustrates only some of the modules of the device from which the determination module 216 receives device statistics. The determination module 216 may receive other device statistics from other modules of the device. After receiving the device statistics, the determination module 216 determines if the policies are satisfied. The plurality of policies may be considered as a set of minimal standards to be satisfied in-order to start the on-device training like, minimum 20% of battery is required or the device is in charged state, performance cores of CPU are free, device temperature to be normal, the device to be in doze mode etc. In an embodiment, the normal temperature for the device is safe device surface temperature according to health standard for operating system of the device. It should be noted that the policies may be configurable and may be configured by the one or more applications. If at least one of the policies is not satisfied, then it is highly undesirable to perform the on-device training as there are high chances of device battery getting drained out, device getting overloaded/ overheated, sluggishness, and hampered user experience.

Referring back to operation 103, if it is determined that based on that the at least one policy is satisfied, then, at operation 105, the method 100 may comprise training the AI model using data associated with the one or more applications. In an embodiment, the data associated with the one or more applications may be captured images for camera/gallery related intelligent AI use cases, user typed words in-case of keyboard. For example, data can be text, voice, image, combination of image and text, etc. In particular, the training module 218 may train the AI model using data associated with the one or more applications.

However, if it is determined that at least one policy is not satisfied, then, at operation 107, a wait period is triggered by the triggering module 220. The wait period may depend on the state of the device. For example, if the device is being used to watch a movie of 2 hours, thereby occupying the resources of the device, then the wait period may be more than 2 hours. Thereafter, the scheduling module 222 may schedule, after expiry of the wait period, the training of the AI model based on redetermination process of determining each of whether the on-device training has been triggered and whether the at least one policy is satisfied. In particular, after the expiry of the wait period, operations 101-103 of the method 100 may be repeated and if at operation 103, it is determined that the at least one policy is satisfied, then the scheduling module 222 may schedule the training of the AI model.

In a further embodiment, referring back to operation 103, if it is determined if the at least one policy is not satisfied, then at operation 109, the prediction module 224 may predict a time period for training the AI model. In an embodiment, the prediction module 224 may predict the time period based on at least one of a user behavior, status of the device, and heuristic data derived from the training request. As shown in FIG. 3, the prediction module 224 may receive various data such as user behavior from the memory 208. For example, an application is ready with data and triggers on-device training request at 7:00 p.m. where on-device training policy is not satisfied as the user of the devices is playing a game or battery of the device is low. The prediction module 224 understands user behavior that the device is free usually after 10:30 p.m. and will be in a charged state from 10:30 p.m. to 12:00 p.m. Accordingly, the prediction module 224 may predict the time period between 10:30 p.m. to 12:00 p.m. to train the AI model.

In another example, consider that the receiving module 214 receive 3 training requests, i.e., task 1, task 2, task 3, predicted to take approximately 5 minutes, 20 minutes, and 1 hour, respectively. Initially, assume that the device was at 90% battery, in idle mode, and is not charging. Then, task 1 is scheduled right now. Further, the prediction module 224, based on the user behavior, predicts that the user leaves the phone idle and charging around 7 p.m. for an extended period of time. So, the prediction module 224 predicts the time period to start tasks 2 and 3 as soon as the user plugs in the device after 7 p.m.

After predicting the time period for training, the scheduling module 222 may schedule the training of the AI model in the predicted time period, based on redetermination process of determining each of whether the on-device training has been triggered and whether the at least one policy is satisfied. In particular, after the expiry of the time period, operations 101-103 of the method 100 may be repeated and if at operation 103, it is determined that the at least one policy is satisfied, then the scheduling module 222 may schedule the training of the AI model.

Referring back to FIG. 1, at operation 105, for training the AI model, the training module 218 may calculate loss function and gradients of loss with respect to weights for each layer of the AI model, wherein the loss function and gradients of loss are calculated for the data associated with the one or more applications. In an embodiment, if the AI model is the backpropagation model, then the on-device training involves backpropagation comprising of loss function, optimizer, and computing the gradients of the loss with respect to weights for each layer that requires training. The training module 218 iteratively computes this gradient of the loss with respect to weights for each trainable layers, which can be projected to the computation of set of operations already present in the inference engine, thus off-loading the layer wise computations alone directly to the inference engine.

The memory 208 handles model weights, biases, and required temporary memory buffers for model weights, intermediates during backpropagation iterations and the dataset batch required for training. In an embodiment, the optimized computation block available in the inference engine are used for performing computations of each operation that are involved in backpropagation. This needs the required tensor data to be copied from the on-device training framework to the on-device inference engine’s memory buffer and copy back after execution of computations. The data copy overhead to and from the inference engine is overcome by the disclosed on-device training engine to extend the inference engine to share the buffer with the training engine.

Then, the graph constructor module 226 may construct at least one graph based on the loss function and gradients of loss. The main function of the graph constructor module 226 is to parse the AI model and create an internal representation understandable by the underlying runtime framework and make necessary modifications to the execution graph based on suggestions set by the training module 218. The graph constructor module 226 does not add additional AI computation nodes; instead, it uses a simple iterative method to iterate over the indexed layers assuming model linearity. Further, the graph constructor module 226 parses the model along with associated weights and maintains the state in the memory 208 for retrieving data while training.

The training module 218 may then train the AI model based on the at least one graph. For example, the training module 218 takes the constructed graph from the graph constructor module 226. The training module 218 updates parameters of the AI model parameters using the constructed graph. In an embodiment, the computations involved in training may be achieved by extending the on-device inference engine.

Thus, the AI model is trained on-device based on the one or more applications running on the device.

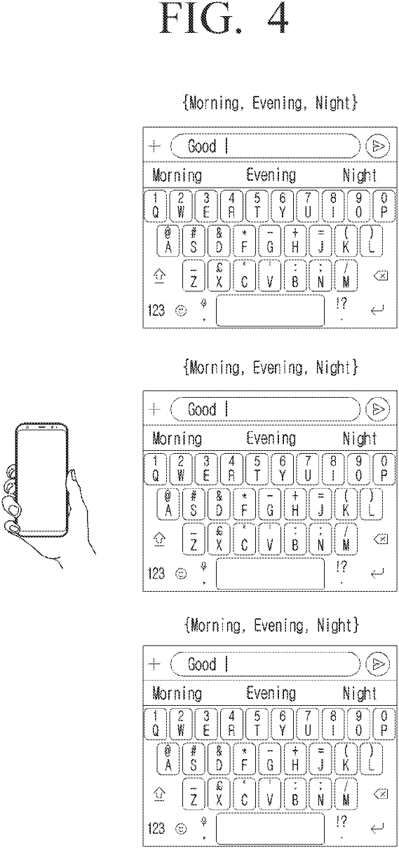

FIGS. 4, 5, and 6 illustrate comparison between an AI keyboard using existing technique and method according to various embodiments of the disclosure.

The typing inputs in the keyboard give very good insight on the user typing pattern. The data collected from user interaction with the keyboard can be used for on-device training to fine tune the next word prediction model to personalize the recommendation for a given user. Since the typed words are very privacy sensitive, the typing cannot be sent over a centralized server for training.

Referring to FIG. 4, the existing next word prediction model the predictions for the word “good” are “Morning,” “Evening,” and “Night,” which are not personalized.

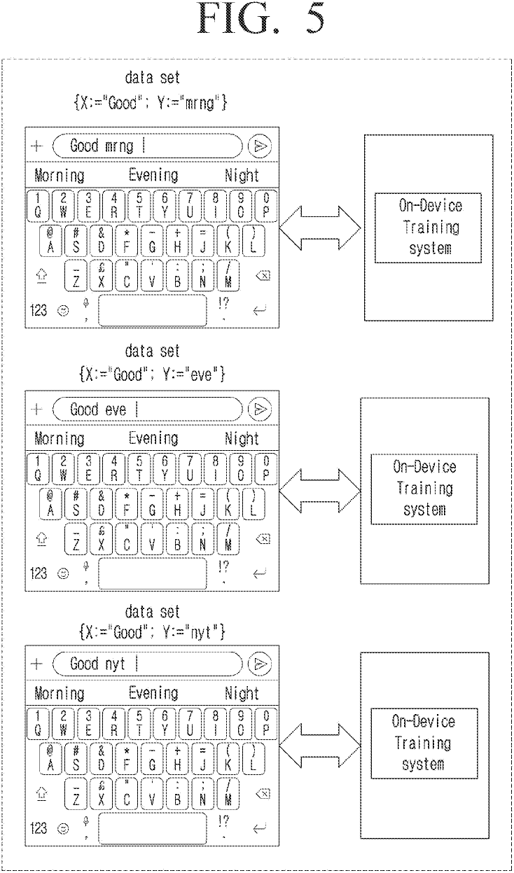

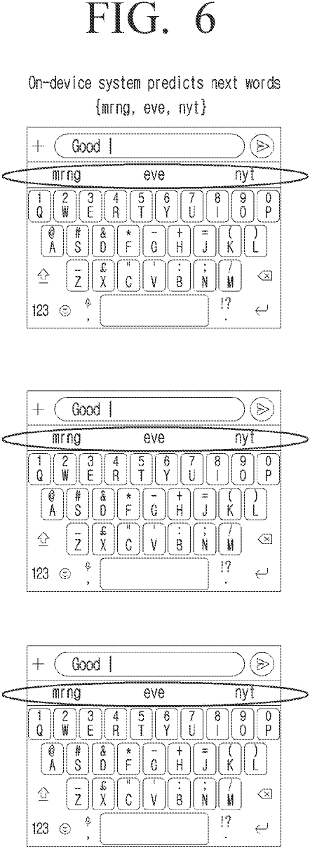

But, according to the user typing pattern, as shown in FIG. 5, according to user behavior, the word “good” is usually followed by words like “mrng,” “eve,” and “nyt.” Accordingly, as data set of {“mrng,” “eve,” and “nyt”} is generated for the word “good.” Hence, upon on-device training using the data points {Good, mrng}, {Good, eve} and {Good, nyt}, the model gets trained according to the user behavior and predicts the next words for word “good” as “mrng,” “eve,” and “nyt,” as shown in FIG. 6.

Similarly, in emoji prediction, the recommendation model suggests suitable emoji based on the user typing pattern. Usage of emoji in chat has become very popular and the choice of emoji is very personalized for each user. For example, the existing emoji recommendation model recommends a cake emoji when “Happy birthday” is typed. It recommends heart emoji when “I love” is typed. It recommends angry emoji when “I am angry” is typed. However, each user may want to use different emoji based on their personal preference. For example, instead of a red heart emoji, users may choose different color hearts. Similarly, instead of cake, the users may prefer a chocolate emoji, and instead of a particular angry emoji a user may prefer some other emoji more suitable based on their preference. The disclosed on-device training over these data points helps in recommending more personalized and suitable emoji.

In another example of a smart widget, the user can select the required widgets like clock, calendar, music player, etc., and enable an auto rotation mode. Based on current user activity, an appropriate widget gets featured. For Example: If the user is exercising in the morning, health widgets get featured. Similarly, if the user connects Bluetooth earphones or earbuds, music widgets get featured, etc. The disclosed on-device training may be used to understand the user behavior and activities like when a user is expected to use which kind of applications and recommend those widgets. Sample data points collected may be such as {X = (Morning, Outdoor, Exercise), Y = (Health Widget)}, {X = (Evening, Outdoor, Travelling), Y = (Music Widget)} etc. The disclosed on-device training over these data points helps in recommending more personalized and suitable widgets.

Thus, the disclosure provides following advantages:

Enforcing privacy of sensitive data via., on-device learning - privacy preservation.

Accelerating on-device training over multiple compute units based on device state and availability (CPU, GPU, NPU and DSP).

Lightweight design avoiding a computation block (operation kernels required for back propagation.

Loosely coupled design and hence independent to work with any existing on-device inference engine.

Handling multiple training requests and intelligently strategizing them.

Maintaining the stability of device with respect to power, performance, and thermal state.

Seamless user experience with enhanced model accuracy and personalization.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An on-device training method to train an artificial intelligence (AI) model on a device, the on-device training method comprising:
receiving a training request for initiating on-device training from one or more applications based on dataset for the on-device training of the AI model being obtained through the one or more applications;
determining whether at least one policy of a plurality of predefined policies regarding state of at least one component included in the device is satisfied, based on the training request; and
training, based on the at least one policy being satisfied, the AI model using data associated with the one or more applications.

2. The method of claim 1, further comprising:
triggering a wait period, if the at least one policy is not satisfied; and
scheduling, after expiry of the wait period, the training of the AI model based on redetermination process of determining each of whether the on-device training has been triggered and whether the at least one policy is satisfied.

3. The method of claim 1, further comprising:
predicting a time period for training the AI model, if the at least one policy is not satisfied; and
scheduling the training of the AI model in the predicted time period, based on redetermination process of determining each of whether the on-device training has been triggered and whether the at least one policy is satisfied.

4. The method of claim 1, wherein the plurality of predefined policies include temperature of the device, state of battery charge of the device, sleep mode status of the device, priority of current tasks running on the device, and availability of device resources.

5. The method of claim 1, wherein training the AI model comprises:
calculating loss function and gradients of loss with respect to weights for each layer of the AI model, based on the data associated with the one or more applications;
constructing at least one graph based on the loss function and gradients of loss; and
training the AI model based on the at least one graph.

6. The method of claim 3,
wherein predicting the time period comprises predicting the time period based on at least one of a user behavior, status of the device, or heuristic data derived from the training request, and
wherein the heuristic data includes a number of operations in each layer of the AI model and time taken to execute the number of operations in each layer of the AI model.

7. The method of claim 1, wherein the AI model is a backpropagation model.

8. The method of claim 1, wherein the one or more applications are AI based applications.

9. The method of claim 1, wherein the at least one policy includes a dataset being sufficient to train the AI model associated with the one or more applications.

10. The method of claim 9, wherein determination of the sufficient dataset is configurable by the one or more applications.

11. The method of claim 9, wherein the sufficient dataset differs according to different applications.

12. An on-device training system to train an artificial intelligence (AI) model on a device, the system comprising:
a receiving module configured to receive a training request for initiating the system from one or more applications based on dataset for on-device training of the AI model being obtained through the one or more applications;
a determination module configured to determine whether at least one policy of a plurality of predefined policies regarding state of at least one component included in the device is satisfied, based on the training request; and
a training module configured to train, based on the at least one policy being satisfied, the AI model using data associated with the one or more applications.

13. The system of claim 12, further comprising:
a triggering module configured to trigger a wait period, if the at least one policy is not satisfied; and
a scheduling module configured to schedule, after expiry of the wait period, the training of the AI model based on redetermination process of determining each of whether the system has been triggered and whether the at least one policy is satisfied.

14. The system of claim 12, further comprising:
a predicting module configured to predict a time period for training the AI model, if the at least one policy is not satisfied; and
a scheduling module configured to schedule the training of the AI model in the predicted time period, based on redetermination process of determining each of whether the system has been triggered and whether the at least one policy is satisfied.

15. The system of claim 12, wherein the plurality of predefined policies include temperature of the device, state of battery recharge of the device, sleep mode status of the device, priority of current tasks running on the device, and availability of device resources.

16. The system of claim 12, wherein for training the AI model, the training module is configured to:
calculate a loss function and gradients of loss with respect to weights for each layer of the AI model, based on the data associated with the one or more applications;
construct at least one graph based on the loss function and gradients of loss; and
train the AI model based on the at least one graph.

17. The system of claim 14,
wherein the predicting module is further configured to predict the time period based on at least one of a user behavior, status of the device, or heuristic data derived from the training request, and
wherein the heuristic data includes a number of operations in each layer of the AI model and time taken to execute the number of operations in each layer of the AI model.

18. The system of claim 12, wherein the AI model is a backpropagation model.
